(19) United States
(12) Patent Application Publication
(10) Pub. No.: US 2007/0127508 A1
(43) Pub. Date: Jun. 7, 2007

(54) System and method for managing the transmission of video data

(76) Inventors: Terry Bahr, Santa Clarita, CA (US); Jay Lukin, Tallahasse, FL (US); Alin Winters, Deerfield Beach, FL (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/472,829

(22) Filed: Jun. 22, 2006

Related U.S. Application Data
(63) Continuation-in-part of application No. 10/846,426, filed on May 15, 2004.
(60) Provisional application No. 60/514,310, filed on Oct. 24, 2003.

(51) Int. Cl. H04L 12/56; H04L 12/28

(52) U.S. Cl. 370/401; 370/229

(57) ABSTRACT

A centralized system for managing video transmission including a gateway serving as an interface between all video capture devices and all viewing devices on the system. All video transmissions must pass through the gateway where they can be identified, managed and monitored accordingly. The system also includes a plurality of video capture devices which capture video data and a plurality of viewing devices that request and receive the video data or a processed form thereof for viewing. In a preferred embodiment, both the video capture devices and the viewing devices are mobile devices.

### RELATED APPLICATIONS

This application is a continuation-in-part application of U.S. patent application Ser. No. 10/846,426, filed May 15, 2004, which claimed priority to U.S. Provisional Patent Application Ser. No. 60/514,310, filed Oct. 24, 2003. This application also claims priority from U.S. Provisional Patent Application Ser. No. 60/692,500, filed Jun. 21, 2005, incorporated herein by reference in its entirety.

### REFERENCE TO COMPUTER PROGRAM LISTINGS

The computer program listings included on the CD accompanying this application, namely AppendixA.txt (25 kb, created Jun. 21, 2006); AppendixB.txt (1 kb, created Jun. 21, 2006); AppendixC.txt (1 kb, created Jun. 21, 2006); AppendixD.txt (2 kb, created Jun. 21, 2006); AppendixE.txt (1 kb, created Jun. 21, 2006); AppendixF.txt (2 kb, created Jun. 21, 2006), are hereby incorporated herein by reference in their entirety.

### FIELD OF THE INVENTION

The present invention relates generally to a system for transmitting video data over a network, and more particularly to a centralized system for managing video steams.

### BACKGROUND OF THE INVENTION

Improvements in processor speeds and increased network bandwidths have facilitated the transmission of video over internet and wireless networks. The introduction of camera phones and java enabled viewers on cell phones have now made it possible to capture video streams with a camera on a cell phone or other wireless device and to view video streams on a cell phone or other wireless device.

However, many obstacles still remain in transmitting video data from a mobile device to a viewer via a network, especially if the viewer is also a mobile device. The diversity of devices and viewers on the market make it difficult to transmit video data that all viewing devices are capable of viewing. Firewalls set up by system administrators add to the difficulty of transmitting video data by blocking the transmission of data to and from remote sites. Additionally, protecting the transmitted video data has also become exceedingly difficult. Most pressing are privacy and security concerns, however, user permissions are also becoming increasingly important. This is especially true when faced with multiple video data streams being transmitted from a number of video capture devices. The video streams must be properly identified and accessible. Only users with permission should be able to view a given video stream. Furthermore, there is a need to monitor user activity and account status with regard to accessing the system and its video streams.

A system must also be capable of managing complex encryption, user authentication and rights and transmission of a variety of data compression formats. The process of encrypting and transmission of video signals initiated from a cellular or wireless device, takes up both processor cycles and higher bandwidth to transmit. This results in higher bandwidth needs for evidential quality data as well as higher machine CPU utilization at the local camera or CCTV system site. Additionally, significant bandwidth limitations for the transmission of full motion, evidentiary quality, streaming video, initiated from a cellular or wireless device, transmitted via cellular networks to cellular devices and hand helds, further impede video data transmission between mobile devices.

### SUMMARY OF THE INVENTION

It is an object of the present invention to provide new and improved systems for centrally managing and monitoring video capture devices and video data transmissions over a network.

It is a further object of the present invention to provide new and improved systems and methods for cellular subscribers to broadcast live video, and asynchronous or synchronized audio directly from their mobile handset to any other mobile subscribers' headsets as well as to any remote computer. The system is capable of streaming the same content to an unlimited number of remote viewers, providing both a unicast and multicast

It is still a further object of the present invention to provide new and improved systems and methods for a camera in a user's cellular or wireless device to become a client/transmission camera on the system. The system allows a user to transmit live, full-motion streaming video on their cellular phone, wireless handheld device, or personal computer, to be viewed from anywhere in the world.

It is yet a further object of the present invention to provide new and improved systems and methods for transmitting live or recorded full motion streaming video, in real time, directly from a cellular device, via platforms and protocols such as LAN, WAN, Wireless LAN, Wireless WAN, GSM Cellular networks, CDMA Cellular networks, TDMA Cellular networks, General Packet Radio Service (GPRS), 1XRT, Internet networks, and Satellite protocol-based networks. This also includes any advanced transmission protocols including: EDGE, EVDO, EGSM, WCDMA, to any personal computer, hand held device (wired or wireless), or cellular phone.

The invention involves the user installing either a compatible broadcaster server or broadcaster software (depending on the application or usage) on their computer and/or cellular phone by connecting to a base station (in residential and SME applications), and downloading compatible cellular viewing software onto their cellular phone or wireless device. Once completed, the user will have the ability to transmit live synchronized video/audio streams from their wireless device, as well as see live video on their cellular phone or wireless hand held device, at any time, from any location with a viable cellular signal.

Briefly, in accordance with the present invention, these and other objects are attained by providing a centralized system for managing video transmission. Rather than having a viewing device connect directly to the video capture device, the system of the present invention has a gateway serving as an interface between all video capture devices and all viewing devices on the system. In this manner, all video transmissions must pass through the gateway where they can be managed and monitored accordingly. The system includes a plurality of video capture devices which capture video data. A plurality of viewing devices are provided that request and receive the video data or a processed form thereof for viewing. As already mentioned, a gateway server functions as the interface between the video capture devices and the viewing devices. The gateway manages the video transmission by applying settings associated with a particular video capture device, viewing device and user account. The settings can include security, permissions, archiving, data transmission rates, data compression, data encryption, etc.

The invention is a significant improvement for business productivity, as workers on remote job sites can now stream live video back to HQ right from their mobile or cellular handsets, or from airports, construction sites, multiple site businesses, hospitals, schools, transport or wherever wireless connectivity may be available.

### BRIEF DESCRIPTION OF THE DRAWINGS

A more complete appreciation of the present invention and many of the attendant advantages thereof will be readily understood by reference to the following detailed description when taken in conjunction with the accompanying drawing, in which:

FIG. 1 is a schematic view of a system according to the present invention.

FIG. 2 is a flow diagram of a system according to the present invention.

FIG. 3 is a screen shot from a viewing device of the present invention showing the selection of a video stream.

FIG. 4 shows two screen shots from the viewing device of the present invention showing the selection of a device and the subsequent selection of a stream transmitted by said device.

### DESCRIPTION OF THE PREFERRED EMBODIMENTS

The invention extends the functionality disclosed in the referenced U.S. patent application Ser. No. 10/846,426, which is incorporated herein by reference.

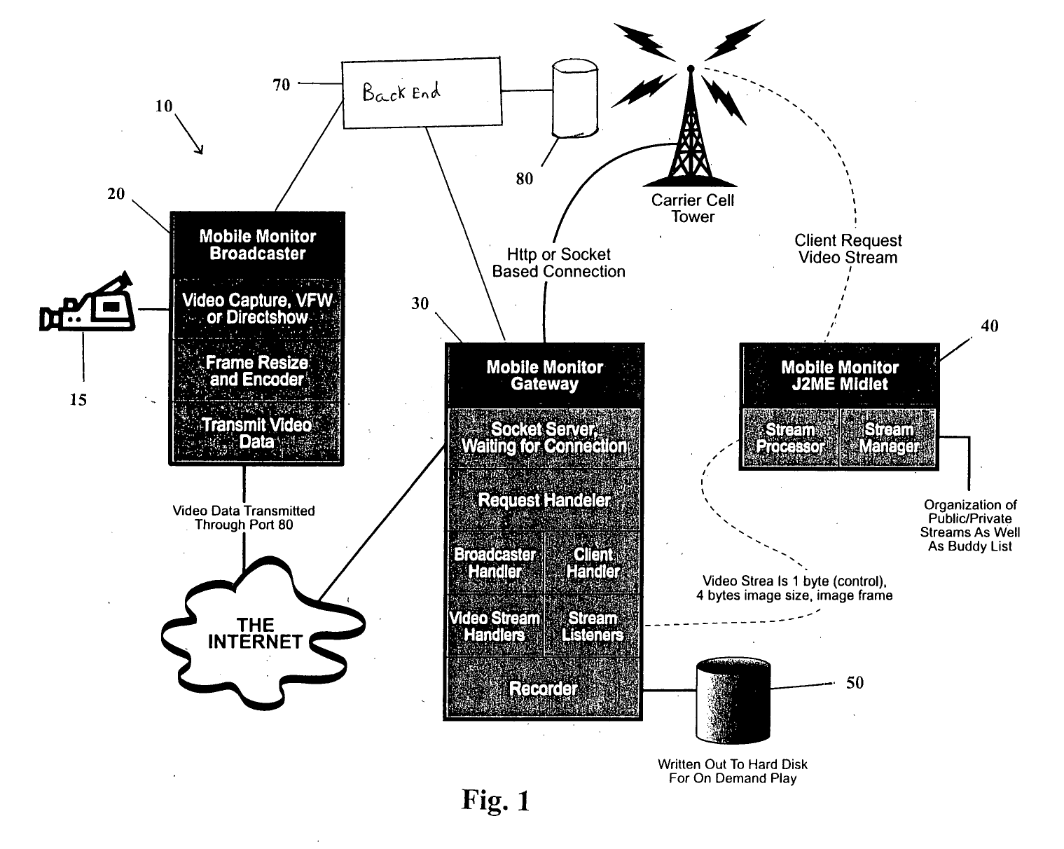

Referring now to the drawings in which like reference characters designate identical or corresponding parts throughout the several views, a preferred embodiment of the system of the present invention, generally designated 10, will now be described with reference to FIGS. 1-4.

Referring now to FIG. 1, the system 10 according to the invention has three main components: a broadcaster component 20, a gateway 30, and a viewing device 40.

The broadcaster component 20 is software running on a processor connected to a video capture device 15. It is understood that the broadcaster software 20 may run on a desktop computer, a mobile phone, or on a dedicated server, as long as they are communicably connected to the video capture device 15. When the broadcast components resides on a cellular phone or any other wireless device, a separate computer is not required to broadcast the video. A sample code for the broadcast software for a cell phone was submitted on a CD as AppendixA.txt.

Furthermore, a number of video capture devices 15 may be connected to a single broadcaster component 20, especially in the instance where the broadcaster component 20 is embodied as a dedicated server. It is also understood that the broadcaster may be embodied as software or as hardware where the functionality is carried out directly from the chipset.

The broadcaster 20 opens and maintains a socket connection to the gateway 30 over which it communicates with the gateway 30. The broadcaster 20 continually checks to insure that the connection is still open. A sample of the broadcast component reconnect code was submitted on a CD as AppendixC.txt. The connection is preferably made through port 80 over the internet to avoid being blocked by a firewall. Although the connection to the gateway 30 is maintained, no video data is sent from the broadcaster 20 until a viewer requests to view the video stream or the system is archiving the video to be viewed at a later time, as is discussed in greater detail below. The broadcaster 20 utilizes either VFW (Video for Windows) or DirectShow (DirectX) API's on the Microsoft Windows Platform.

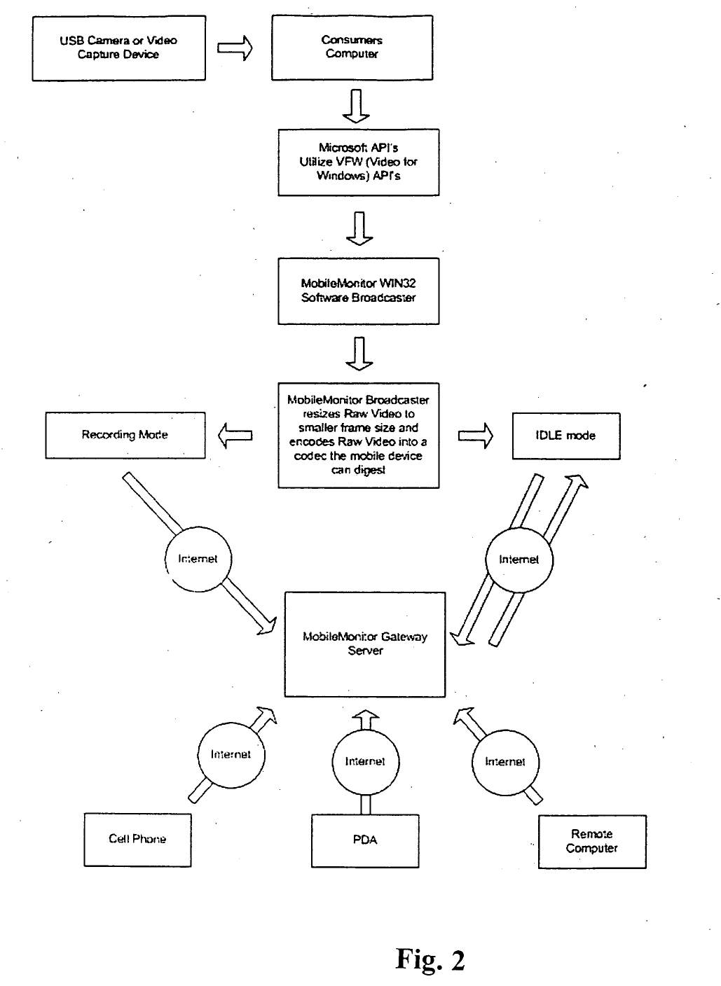

Referring now to FIG. 2, each video capture device 15 captures the analogue or digital video and/or audio data into the digital domain. Examples of video capture devices are dome cameras, CCTV, webcams, cell phone cameras, cameras on wireless devices, and any other camera that can be communicably connected to the broadcaster component. The image and source data are captured by the video capture device 15 in raw video (RGB, YUV, or I420) format and digital audio (if applicable depending on the installation). The broadcaster 20 receives the raw video and has the capability to encode the video in a variety of formats including: 3gp, 3gpp, PNG, full motion JPEG, MPEG 2, and MPEG 4 depending on the user settings. The captured video source is encoded into the appropriate inner frame codec by the broadcaster component 20. The broadcaster 20 uses 3rd party license-free win32 or similar libraries to do the initial encoding for either PNG or JPEG or a variety of inner frame codecs, as previously defined. The frame rate at which the images are captured is set and encoded. The broadcaster also has the ability to set image frame size and color depth of image frame dynamically. After the raw video data is encoded it is transmitted to the gateway 30. The broadcaster component 20 also has the ability to list the viewing devices viewing a particular stream as well as log data associated with the video stream transmission and its viewers. A sample of the broadcaster code was submitted on a CD as AppendixB.txt.

Referring again to FIG. 1, upon startup or reboot of the broadcaster component 20, a connection is made to the backend system 70 to retrieve settings associated with the video devices connected to the broadcaster component. The settings are stored in a settings database 80 coupled to the backend system 70. A user may access and enter or edit the settings associated with one or more devices via a secure website. This allows the user to centrally and remotely manage all devices associated with the user's account. The settings can include security, permissions, archiving, frame rates, data transmission rates, data compression, data encryption, etc. The broadcaster component 20 also receives software updates via this connection to the backend system 70.

The gateway 30 is a server or a cluster of servers that functions as the central hub or interface between the broadcaster component 20 and the viewing device 40. The gateway 30 is a Java socket server with a dedicated publicly addressable IP address that listens on port 80 (or other applicable port) for incoming connections. The gateway 30 enables the video data transmitted from the broadcaster component 20 to get through most firewalls.

The gateway 30 receives connections from all broadcasters on the system and identifies the connections and the video streams available via those connection so that the viewer can select a particular video stream. The gateway utilizes connection pooling which allows the system to “accept” multiple connections in a separate thread for each new connection and pass it off to the appropriate request handler. An example of the gateway connection handling code was submitted on a CD as AppendixD.txt. The gateway 30 also controls the permissions to each video stream. A log is kept of each viewing device and user account that viewed a particular thread, as well as other data associated with viewing the stream. The gateway 30 can write streams and other logged data to a database 50 for archiving, as is described in greater detail below. A cluster of gateway servers is beneficial because it allows the system 10 to do load management of the devices connected to the system 10. The video streams may be spread out over the multiple gateway servers so that the workload is evenly distributed. Preferably, the gateway checks the version of the broadcaster component to insure that the broadcaster 20 is running the most updated version of the software. If the broadcaster software is outdated, the gateway 30 sends a call to the broadcaster to reboot. Upon reboot, the broadcaster component 20 connects to the backend system 70 to retrieve the update, as described above.

The third main component of the system is the viewing device 40. The viewing device 40 can be a mobile device such as a cell phone or a PDA with wireless capabilities, as well as a remote personal computer. The viewing device 40 includes software that connects to the gateway 20 to query the gateway about available video streams as well as to retrieve and view selected streams. In the case of a cell phone or other wireless device the software is a Midlet or Wireless Device Application software that runs on any J2ME enabled device, Pocket PC, PALM, Symbian, Smart Phone, DOJA or Brew or similar. The application works on J2ME handsets (GSM and CDMA cellular networks), Microsoft Smartphone 2003, Microsoft Pocket PC Mobile Edition, Palm Treo, Blackberry, and BREW enabled cellular handsets, and others with compatible features or with minimal adaptation to the current invention. The viewing device's main purpose is to display a video stream from a particular software Broadcaster 20. Sample code from the midlet and Wireless Device Application Software were submitted on a CD as AppendixF.txt.

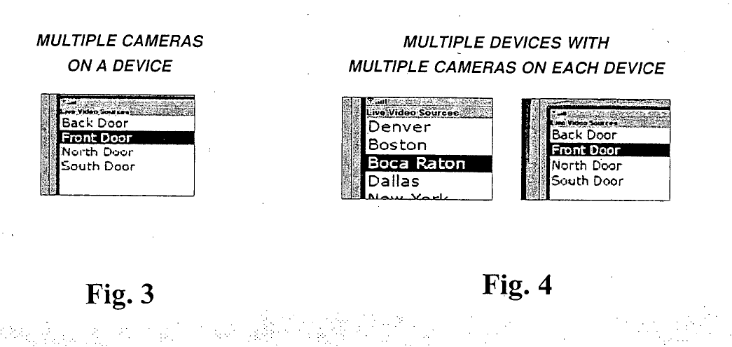

Referring again to FIG. 2, the viewer 40 connects to the gateway 30 to query the gateway regarding available streams. A user can use the viewer to connect to the gateway, login to the system, and select a video stream that is available to the user. Upon connection to the gateway 30, the user account information is checked by the gateway for security clearance, permissions to individual video streams and for any other settings associated with the user account or the viewing device being used by the user. The gateway checks the settings by connecting to the backend system 70 which in turn accesses the settings database 80 to retrieve the user account information and settings. The user then uses an interface on the viewer 40 to choose a broadcaster device 20 and then to choose a particular video stream from a particular video capture device 15 on that broadcaster. An example of the viewer interface is shown in FIGS. 3 and 4.

Once a video stream has been selected, the gateway 30 sends a call to the broadcasting component 20 to begin transmitting the video data. The video stream packet protocol comes down as 1 byte control, 4 bytes cast to integer for image payload size, and then the image payload bytes respectively. J2ME methods, createImage for PNG and JPG frames or createRGBImage for inner frames are called respectively to display that image on the Canvas. This process is repeated until EOS (End of Stream) or user aborts viewing. The system does not require the use of any third party video players such as Windows Media Player, or Real Player, but will have selected compatibilities with such third party players.

Streams can be set as public or private streams with password protection for the private streams. Once the user has authenticated to the gateway server 30, and chooses to start broadcasting, the user is prompted to enter a 20-character stream name and a password if it is a private stream. The stream name is a user-defined identifier used by clients to identify their stream. The stream name information and password are then transmitted to the gateway server component to notify it of its incoming video stream. Until the user requested the stream no video data was transmitted to the gateway. This assures that the bandwidth is not wasted on video data that is not being viewed.

Furthermore, the user may adjust the settings of a particular broadcaster or particular stream to be set on an archive or record mode. In this case, shown in FIG. 2, the broadcaster continually sends the video data to the gateway which writes the video data to a database 50. It is understood that the system could also be set up so that the gateway 30 relays the video data to the backend system 70 which records the video data in a separate database. In the archiving mode, the callback function for the video stream is called and the appropriate actions to resize the video from 320×240 to the appropriate frame size take place. It will then encode into the appropriate codec of the consumer's choosing and then transmit that video data to the gateway server component. It continues this process until the consumer stops broadcasting, which in turn notifies the software gateway server component the video stream has finished.

The description provided above indicates that a great degree of flexibility exists with the system and method. Although the system and method of the present invention have been described with considerable detail with reference to certain preferred embodiments thereof, other embodiments are possible. Therefore the spirit and scope of the appended claims should not be limited to the description of the preferred versions contained herein.

1. A system for managing video transmission, comprising:
at least one video capture device which captures video data;
at least one broadcaster component coupled to at least one of said at least one video capture device, wherein said broadcaster component processes said video data;
at least one viewing device which receives and displays said video data or a processed form of said video data;
a gateway, wherein said at least one viewing device and said at least one broadcaster component interface via said gateway to transmit said processed video data from said at least one broadcaster component to said at least one viewing device.

2. The system of claim 1, wherein all of said at least one broadcaster component maintain an idle connection with said gateway until one of said at least one viewing device requests from said gateway selected video data from a particular one of said at least one broadcaster components at which time said particular broadcaster component transmits said selected video data to said gateway.

3. The system according to claim 1, wherein said gateway identifies each video capture device associated with each of said at least one broadcaster component and displays said identified video capture devices to said at least one viewing device so that said at least one viewing device can select a viewing device from which to receive video data.

4. The system according to claim 1, wherein the gateway comprises a plurality of gateway servers communicably coupled with each other and wherein said servers are load balanced to distribute data traffic between them.

5. The system of claim 1, further comprising a backend system including a database for storing user account settings, and settings associated with said at least one video capture device and said at least one viewing device.

6. The system of claim 1, wherein said video capture device is a component of a wireless mobile device and said broadcaster component runs on said mobile device.

7. The system of claim 6, wherein said viewing device is a wireless mobile device.

8. A method for managing the transmission of video data from at least one video capture device to at least one viewing device, comprising the steps of:
providing at least one broadcaster component coupled to said at least one video capture device that encodes said video data;
providing a gateway interface between said broadcaster component and said viewing device;
maintaining an idle connection between said gateway and said at least one broadcaster component;
identifying and listing for said at least one viewing device a list of said at least one video capture device connected to said gateway via said at least one broadcaster component;
selecting a particular video capture device from said list provided by said gateway;
notifying the broadcaster coupled to said particular video capture device of said selection;
transmitting video data from said broadcaster to said viewing device via said gateway.

9. The method of claim 8, wherein said video capture device is a component of a wireless mobile device.

10. The method of claim 9, wherein said viewing device is a wireless mobile device.
